(19) United States
(12) Patent Application Publication
(10) Pub. No.: US 2008/0300381 A1
(43) Pub. Date: Dec. 4, 2008

(54) Electrode Material and Electrochemical Device

(75) Inventors: Hidenori Uchi, Tokyo (JP); Kenji Tamamitsu, Tokyo (JP); Shunzo Suematsu, Tokyo (JP); Satoru Tsumeda, Tokyo (JP); Alexander M. Timonov, Saint Petersburg (RU); Sergey A. Logvinov, Lenningrad (RU); Nikolay Shkolnik, West Hartford, CT (US); Sam Kogan, Newton Center, MA (US)

Correspondence Address: PILLSBURY WINTHROP SHAW PITTMAN, LLP, P.O. BOX 10500, MCLEAN, VA, 22102, US

(73) Assignee: NIPPON CHEMI-CON CORPORATION, TOKYO JAPAN (JP)

(21) Appl. No.: 11/664,281

(22) PCT Filed: Sep. 30, 2004
(86) PCT No.: PCT/JP04/14764

§ 371 Date: Mar. 28, 2008

(51) Int. Cl. C08G 79/00

(52) U.S. Cl. 528/395

(57) ABSTRACT

To provide an electrode material excellent in output characteristics and cycle property and an electrochemical device using the electrode material. The electrode material comprising polymer complex compound represented by the following graphical formula: and the electrochemical device using the electrode material. Even if such a large size ion is employed, enhanced output characteristics could be obtained in the present invention. Polymer complex compound is polarized due to an electron attracting substituent, or steric hindrance occurs due to a substituent having a branch structure so that interval of polymer complex compound formed on the electrode is increased and doping reaction. Therefore, even if using large size ions smooth and rapid doping and undoping reaction could take place.

### FIELD OF THE INVENTION

The present invention relates to an electrode material and an electrochemical device such as a secondary battery and capacitor using the electrode material, and for more detail, relates to an electrode material excellent in output characteristics and cycle property and an electrochemical device using the electrode material.

### BACKGROUND OF THE INVENTION

In these years, an electric automobile and hybrid car have been expected instead of a gasoline-powered vehicle and diesel-powered vehicle which are diesel-driven. In these electric automobile and hybrid car, an electrochemical device having high energy density and high output density properties used as a power source for driving a motor. A secondary battery and a double electric layer capacitor are listed as such electrochemical device.

As the secondary battery, a lead battery, nickel/cadmium battery, nickel hydride battery, or proton battery and so on are listed. These secondary batteries use acidic or alkaline aqueous electrolyte solution which is high ionic conductivity, thereby to have excellent output characteristics that large electric current is obtained when charging and discharging, however electrolysis voltage of water is 1.23V, therefore higher voltage may not be obtained. As a power source of the electric automobile, a high voltage of approximately 200V is required, therefore many batteries by just that much must be connected in series, resulting in disadvantage for downsizing and trimming weight of the power source.

As a secondary battery of high voltage type, a lithium ion secondary battery using organic electrolyte solution is known. This lithium ion secondary battery uses an organic solvent with high electrolysis voltage as an electrolyte solvent, therefore when the lithium ion showing the lowest potential is an electric charge relating to charge/discharge reaction, potential of 3V or more is shown. The lithium ion secondary battery brings a battery using carbon occluding and releasing the lithium ion as a negative electrode and cobalt acid lithium (LiCoO₂) as a positive electrode into mainstream. An electrolyte solution dissolving lithium salt such as hexafluorophophate lithium (LiPF₆) into a solvent such as ethylene carbonate and propylene carbonate is used.

However, this lithium ion secondary battery is high in voltage and high in energy density to be excellent as a power source, however charge reaction is occlusion and release of the lithium ion of the electrode, therefore the secondary battery has a problem to be inferior in output characteristics, which is a disadvantage for the power source for the electric automobile requiring large instantaneous current. Then, there is an approach using derivative of polythiophene as a positive electrode for improving the charge/discharge property at a high voltage (Japanese Laid-Open Patent Publication No. 2003-297362).

An double electric layer capacitor also uses a polarizable electrode such as activated carbon as positive and negative electrodes, and uses a solution dissolving quaternary onium salt of boron tetrafluoride or phosphorus hexafluoride into an organic solvent such as propylene carbonate. Thus, the double electric layer capacitor regards an double electric layer generating at the boundary surface between the surface of the electrode and the electrolyte solution as an electric capacitance, and there is no reaction involving ions such as in a battery, thus the charge/discharge property is high and deterioration in capacity due to charge/discharge cycle is reduced. However, energy density due to double layer capacity is low in the energy density compared to the battery, which is significantly insufficient as a power source of the electric automobile. At the same time, there is an approach using polypyrrole as a positive electrode for the purpose of large capacity (Japanese Laid-Open Patent Publication No. H6-104141).

Then, an electrochemical capacitor using conductive polymer and metal oxide as an electrode material which is high in energy density and high in output characteristics has been developed. An electric charge storage mechanism of this electrochemical capacitor is adsorption and desorption of anion and cation in the electrolyte solution onto the electrode, and both energy density and output characteristics are excellent. Particularly, an electrochemical capacitor using conductive polymer such as polyaniline, polypyrrole, polyacene, and polythiophene derivatives performs charge and discharge by p-doping or n-doping of anion or cation in non-aqueous electrolyte solution onto the conductive polymer. The potential of this doping is low at a side of negative electrode and high at a side of positive electrode, therefore a high voltage property is obtained (Japanese Laid-Open Patent Publication No. 2000-315527).

However, the capacitor using the above conductive polymer was also desired to improved energy density and out put characteristics. In order to comply with the above desire, an energy storage device, such as a battery or super capacitor, is developed that includes at least two electrodes, at least one of the electrodes includes an electrically conducting substrate having a layer of energy accumulating redox polymer complex compound of transition metal having at least two different degrees of oxidation, which polymer complex compound is formed of stacked transition metal complex monomers. In the energy storage device, the stacked transition metal complex monomers have a planar structure with the deviation from the plane of no greater than 0.1 nm and a branched system of conjugated pi-bonds, the polymer complex compound of transition metal can be formed as a polymer metal complex with substituted tetra-dentate Schiff's base, and the layer thickness of redox polymer is within the range 1 nm-20 m (International Patent Publication No. WO03/065536). Further, the above polymer complex compound may be used for both positive and negative electrodes since it's central metal could be reversibly oxidized-reduced. The capacitor using these electrodes as the both electrodes allows to have a high operating voltage of 3V and a high energy density of 300 Jg⁻¹, and a method for producing it by which this energy density is obtained is also described (International Patent Publication No. WO 04/030123). In addition, the above polymer complex compound generally has a columnar structure with vertical orientation so that ions move around the columnar polymers smoothly. Therefore, there is a possibility that high output characteristics has been developed.

### SUMMARY OF THE INVENTION

### Problems to Be Solved by the Invention

However, it is found that the output characteristics goes down when relatively large ions such as quaternary ammonium cation used in the double electric layer capacitor or in the electrochemical capacitor is employed. Then, an object of the present invention is to provide an electrode material having high output characteristics in spite of using large size ions as described above and an electrochemical device using the electrode material.

### Means for Solving the Problems

The present invention is an electrode material comprising polymer complex compound represented by the following graphical formula:

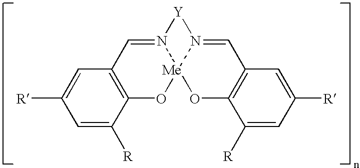

wherein Me is transition metal,

R is electron attracting substituent,

R′ is H or electron attracting substituent,

Y is

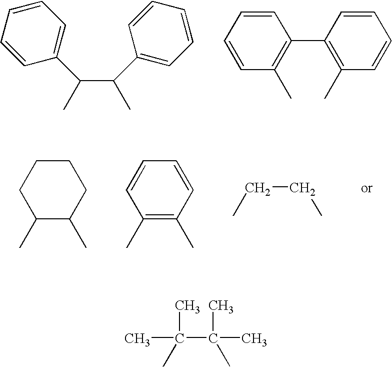

and when using an electrode material where n is an integer number of 2 to 200000, it is found that the electrochemical device having excellent cycle property and high output characteristics is obtained. In particular, as a preferable transition metal Me, Ni, Pd, Co, Cu, and Fe are listed. Also as a preferable R, CH₃O—, C₂H₅O—, HO— and —CH₃ are listed.

And by using this electrode and using an electrolyte solution containing lithium cation or proton, a secondary battery having high output characteristics may be provided.

Further, by using this electrode and using the electrolyte solution containing quaternary ammonium cation or quaternary phosphonium cation, an electrochemical capacitor having high output characteristics may be provided.

### EFFECT OF THE INVENTION

By using electrode material comprising the above polymer complex compound, electrolysis voltage of ligand portion of polymer complex compound is increased, thereby to improve cycle property. Also in such a electrode material, polymer complex compound is polarized due to an electron attracting substituent, or steric hindrance occurs due to a substituent having a branch structure, thereby interval of polymer complex compound formed on the electrode is increased, then reaction of doping and dedoping of doped ions speeds up to improve output characteristics. Thus, the present invention may obtain the electrode material which is excellent in cycle property and which has high output characteristics and the electrochemical device using the electrode material.

### BRIEF DESCRIPTION OF THE DRAWINGS

FIG. 1 is a schematic view showing a stacked state of polymer metal complex.

FIG. 2. a) is a schematic view showing polymer metal complex in an oxidized state bonded on electrode surface by chemical adsorption,

b) is a schematic view showing polymer metal complex in a reduced state bonded on the electrode surface by the chemical adsorption.

FIG. 3. a) is a schematic view when polymer metal complex is in a neutral state,

b) is a schematic view when polymer metal complex is in an oxidized state.

### DETAILED DESCRIPTION OF THE INVENTION

According to the principles of the present invention a redox polymer complex compound of transition metal is configured as “unidirectional” or “stack” macromolecules.

Representatives of the group of polymer metal suitable for the electrodes fall into the class of redox polymers, which provide novice anisotropic electronic redox conduction. For more detail on these polymer complexes, see Timonov A. M., Shagisultanova G. A., Popeko I. E. Polymeric Partially-Oxidized Complexes of Nickel, Palladium and Platinum with Schiff Bases//Workshop on Platinum Chemistry. Fundamental and Applied Aspects. Italy, Ferrara, 1991. P. 28.

Formation of bonds between fragments can be considered, in the first approximation, as a donor-acceptor intermolecular interaction between a ligand of one molecule and the metal center of another molecule. Formation of the so-called “unidimensional” or “stack” macromolecules takes place as a result of said interaction. Such a mechanism of the formation of “stack” structures of a polymer currently is best achieved when using monomers of square-planar spatial structure. Schematically this structure can be presented as follows:

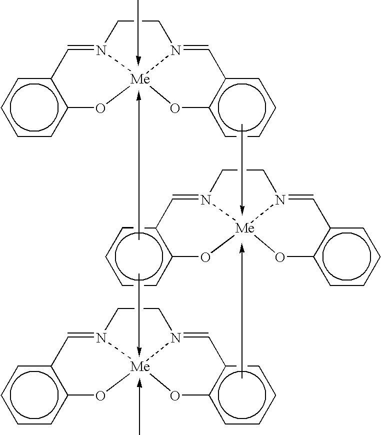

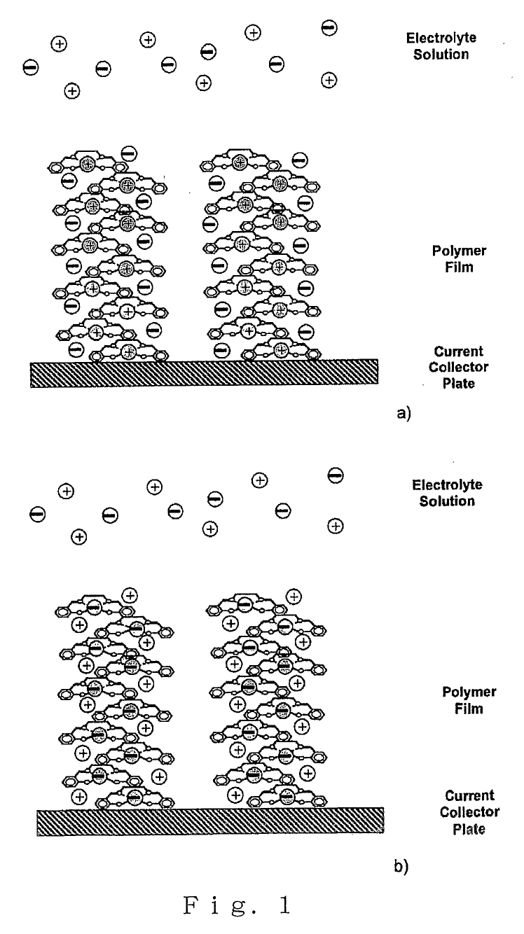

Superficially a set of such macromolecules looks to the unaided eye like a solid transparent film on an electrode surface. The color of this film may vary depending on the nature of metal and presence of substitutes in the ligand structure. But when magnified, the stack structures become evident, see FIG. 1.

Polymer metal complexes are bonded with the inter-electrode surface due to chemisorption.

Charge transfer in polymer metal complexes is effected due to “electron hopping” between metal centers with different states of charge. Charge transfer can be described mathematically with the aid of a diffusion model. Oxidation or reduction of polymer metal complexes, associated with the change in the states of charge of metal centers and with directed charge transfer over polymer chain, is accompanied, to maintain overall electrical neutrality of the system, by penetration into a polymer of charge-compensating counter-ions that are present in the electrolyte solution surrounding the polymer or by the egress of charge-compensating counter-ions from the polymer.

The existence of metal centers in different states of charge in a polymer metal complex is the reason for calling them “mixed-valence” complexes or “partially-oxidized” complexes.

The metal center in the exemplary polymer complex poly-[Ni(CH3O-Salen)] may be in one of three states of charge:

Ni²⁺-neutral state;

Ni³⁺-oxidized state;

Ni⁺-reduced state.

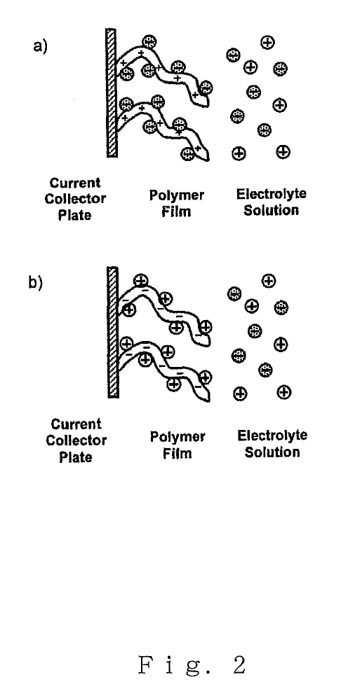

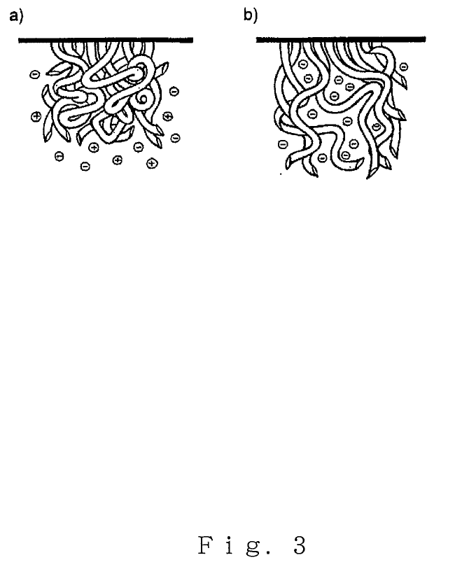

When this polymer is in the neutral state (FIG. 3a), its monomer fragments are not charged and the charge of the metal center is compensated by the charge of the ligand environment. When this polymer is in the oxidized state (FIG. 3b), its monomer fragments have a positive charge, and when it is in the reduced state, its monomer fragments have a negative charge. To neutralize spatial (volume) charge of a polymer when the latter is in the oxidized state, electrolyte anions are introduced into the polymer structure. When this polymer is in the reduced state, neutralization of the net charge results due to the introduction of cations (see FIG. 2).

Then, manufacturing process of polymer complex compound of transition metal and an electrode using the polymer complex compound of transition metal according to an embodiment of the present invention will be described. At first, an electrode coated on an electric collector plate with carbon or metal structure is regarded as a work electrode, which is immersed in dissolved electrolyte solution of complex monomer, and an activated carbon electrode is regarded as a counter electrode, then an electro polymerization is performed by applying a constant electric potential to a reference electrode to obtain the polymer complex compound of transition metal from the complex monomer.

Thus, electrolyte solution dissolving the complex monomer is used, thereby elution of the complex monomer into the electrolyte solution during polymerization is suppressed, while polymerization of the complex monomer dissolved into the electrolyte solution is enabled, resulting in achieving improvement of an amount of polymerization per unit time and unit square measure.

Also a manufacturing process method of polymer complex compound of transition metal and an electrode using the polymer complex compound of transition metal according to another embodiment of the present invention comprises the steps of: stacking a film comprising a mixture of the above complex monomer and conductive auxiliary substance on the electric collector plate to perform film forming, thereafter drying the same to form an electrode; immersing this electrode into an electrolyte solution; performing an electro polymerization by applying a constant level of electric potential to a reference electrode in the use of an activated carbon electrode as a counter electrode, thereby to obtain the polymer complex compound of transition metal.

These polymer complex compound of transition metal is formed as an electrode comprising a film formed on the surface of the electric collector plate, thus that may be used as a constituent of device for battery, capacitor and so on without any process. Therefore, an electrode containing the polymer complex compound of transition metal may be obtained in a simple and short process.

In addition, in the electro polymerization of the present invention, polymerization is performed by immersing the above electrode into the electrolyte solution and applying an oxidation potential of the complex monomer to the reference electrode with using the activated carbon electrode as a counter electrode or flowing oxidation current, however not only such a triple pole type but also double pole type may be used.

The electrolyte solution dissolving the complex monomer used in the electro polymerization of the present invention may use as a solvent therefor a solvent of which solubility of the complex monomer is 0.01 to 50 wt %, more preferably 0.01 to 10 wt %. When the solubility is higher than this value, the complex monomer becomes easy to elute into the electrolyte solution, the complex monomer fixed and condensed on the electric collector plate decreases, thereby efficiency of the manufacturing is down. Meanwhile, when the solubility is lower than this value, namely when the electro polymerization is performed in the electrolyte solution using the solvent in which the complex monomer is almost insoluble, polymerization characteristics of the complex monomer is lowered, thereby excellent polymer complex compound of transition metal may not be obtained. By using the electrolyte solution having the solubility in the above range, improvement in yield of the polymer complex compound of transition metal may be achieved without elution of the complex monomer or the formed polymer complex compound of transition metal more than necessary from the electrode. In addition, the solvent of the electrolyte solution dissolving the complex monomer is not limited to whether water or organic solvent as long as it is available.

As the electrolyte solution dissolving the complex monomer used for the electro polymerization of the present invention, a salt which is soluble in water of, for instance, alkaline metal salt, alkaline earth metal salt, organic sulphonate, sulphate salt, nitrate salt, perchlorate, and so on and which can ensure ions conductivity is preferably used as a supporting electrolyte solution in the case of aqueous solution and both the kind and concentration are not limited. Further, if required, protonic acid of the above salt may be used or another proton source may be added.

As electro polymerization mode, for instance, potential sweep polymerization method, constant potential polymerization method, constant current polymerization method, and potential step method as well as potential pulse method are listed, however in particular, the potential pulse method may be used in the present invention. In the electrode material in the present invention, the polymer metal complex in an oxidized state may be used as a charged state of the positive electrode and a reduced state may be used as a charged state of the negative electrode, therefore the electrode material may be used for both positive and negative electrodes.

An electrochemical device using the above electrode and the below electrolyte solution may be formed. The used electrolyte solution may be non-aqueous type and aqueous type. When using a non-aqueous electrolyte solution, solvent preferably contains one or more substances selected from a group constituted of ethylene carbonate, propylene carbonate, butylene carbonate, dimethyl carbonate, ethylmethyl carbonate, diethyl carbonate, sulphorane, acetonitrile, and dimethoxy ethane. As a solute, lithium salt having the lithium ion, quaternary ammonium salt or quaternary phosphonium salt having quaternary ammonium cation or quaternary phosphonium cation respectively may be listed. As lithium salt, LiPF₆, LiBF₄, LiClO₄, LiN(CF₃SO₂)₂, LiCF₃SO₃, LiC(SO₂CF₃)₃, LiAsF₆ and LiSbF₆ and so on are listed. Also as quaternary ammonium salt or quaternary phosphonium salt, may be preferably a salt comprising cation expressed by R1 R2 R3 R4N+ or R1 R2 R3 R4 P+ (where R1, R2, R3, R4 are alkyl group with the number of carbon of 1 to 6), and anion consisting of PF6−, BF4−, ClO4−, N(CF3SO2)2−, C3SO3—, C(SO2CF3)3−, AsF6− or SbF6−. In particular, PF6−, BF4−, ClO4−, and N(CF3SO2)2− are preferably to be anion.

As aqueous electrolyte solution, alkaline metal such as sodium and potassium or a proton is used as a cation. As an anion, anion forming together with proton an inorganic acid such as sulfuric acid, nitric acid, hydrochloric acid, phosphoric acid, tetrafluoroborate, hexafluorophosphate, and hexafluorosilicate, and an organic acid such as saturated monocarboxylic acid, aliphatic carboxylic acid, oxycarboxylic acid, para-toluenesulfonic acid, polyvinyl sulfonic acid, and lauric acid may be listed.

An electrochemical device of the present invention will be described below.

### (Secondary Battery)

A secondary battery may be prepared as following. In the case of lithium secondary battery, a non-aqueous electrolyte solution dissolving lithium salt as a solute is used as an electrolyte solution. And, the polymer metal complex of the present invention is used as a positive electrode, and an electrode material capable of occluding and releasing lithium such as lithium metal or carbon occluding and releasing lithium is used as a negative electrode. The above secondary battery of the present invention improves output characteristics due to effect of electron attracting substituent. Also when using the electrode of the present invention for the negative electrode and using lithium metal oxide such as LiCoO2 for the positive electrode, the output characteristics is improved. The electrode of the present invention is more excellent in output characteristics than the electrode material capable of occluding and releasing lithium such as lithium metal or carbon occluding and releasing lithium, therefore when using the electrode of the present invention as the negative electrode, the output characteristics and cycle property are significantly improved than the electrode material capable of occluding and releasing the lithium. Further, more large ionic diameter of solvated cation, more effective in doping/dedoping reaction of the cation the electrode of the present invention may be, therefore use of the electrode of the present invention for the negative electrode makes a contribution more significantly than the use of the electrode for the positive electrode.

Also when forming proton battery, acid aqueous solution having proton as the electrolyte solution is used. When using the electrode of the present invention for the positive electrode and using a negative electrode of the proton battery such as quinoxaline based polymer as a negative electrode, the output characteristics is improved due to effect of electron attracting substituent.

### (Double Electric Layer Capacitor)

A double electric layer capacitor may be prepared as following. All of the above non-aqueous type and aqueous type may be used as an electrolyte solution. When using the electrode of the present invention as a positive electrode and using an electrode such as an activated carbon which has double electric layer capacity as a negative electrode, this double electric layer capacitor is improved in output characteristics due to effect of electron attracting substituent. Also when using the electrode having the double electric layer capacity as a positive electrode and using a negative electrode of the present invention as a negative electrode, use of the electrode of the present invention for the negative electrode is more effective than the use of the electrode for the positive electrode in the same way as the case of the secondary battery, therefore a drastic improvement in output characteristics is obtained.

### (Electrochemical Capacitor)

An electrochemical capacitor may be prepared as following. As an electrolyte solution, a non-aqueous electrolyte solution dissolving quaternary ammonium salt or quaternary phosphonium salt as a solute is used. When using the electrode of the present invention as a positive electrode and using conductive polymer such as polythiophene having redox reaction responsiveness as a negative electrode, output characteristics is improved due to effect of electron attracting substituent. And when using metal oxide such as the conductive polymer or ruthenium oxide as a positive electrode and using the negative electrode of the present invention as a negative electrode, the use of the electrode of the present invention for the negative electrode is more effective than the use of the electrode for the positive electrode in the case of the secondary battery, therefore a drastic improvement in output characteristics is obtained. Further, the polymer complex electrode may be used for both positive and negative electrodes as described above, therefore the electrode of the present invention may be used for both electrodes, thereby to obtain an electrochemical capacitor excellent in output characteristics.

### EXAMPLE

The present invention will be further specifically described below using examples.

By using an acetonitrile solution containing [Ni(salen)-(NO₂)₂] of 1 mM and TEABF4 of 0.1M as an electrolyte solution for electrolysis, carbon fiber organizer electrode (project area is 1 cm²) for a work electrode as an electrode, a silver/silver ion (Ag/Ag+) electrode for a reference electrode, and an activated carbon tissue (project area is 10 cm² and specific surface area is 2500 m²g⁻¹) for a counter electrode, an electrochemical cell (chemical cell) is structured, and then a constant potential electro polymerization is performed in conditions of potential of 1.0V vs. Ag/Ag+, electrolysis time of 1 second, and downtime of 30 second at an amount of polymerization electric charge of examples 1 to 3 and comparative examples 1 to 3 shown in Table 1. After polymerization, the work electrode is cleaned with acetonitrile and dried. Then, the electrochemical cell including electrolyte solution for capacity estimation is structured using these electrodes, ands the capacity is calculated from cyclic voltammetry to show energy in Table 1.

Comparative examples are carried out by a constant potential electro polymerization.

TABLE 1
constant potential electro polymerization

| | | | | amount of | |
|---|---|---|---|---|---|
| | | | | polymerization | |
| | negative | | electrolyte | charge | energy |
| | electrode | positive electrode | solution | (C cm-2) | (mJ cm-2) |
| Example 1 | lithium metal | Poly[Ni(salen)-(NO₂)₂] | LiClO4-PC | 0.5 | 323 |
| | | | | 1 | 533 |
| | | | | 3 | 1269 |
| Example 2 | activated carbon | Poly[Ni(salen)-(NO₂)₂] | TEABF4-Me | 0.5 | 250 |
| | | | CN | 1 | 413 |
| | | | | 3 | 983 |
| Example 3 | Poly[Ni(salen)- | Poly[Ni(salen)-(NO₂)₂] | TEABF4-Me | 0.5 | 291 |
| | (NO₂)₂] | | CN | 1 | 481 |
| | | | | 3 | 1143 |
| Comparative | lithium metal | Poly[Ni(salen)] | LiClO4-PC | 0.5 | 228 |
| example 1 | | | | 1 | 267 |
| | | | | 3 | 576 |
| Comparative | activated carbon | activated carbon | TEABF4-Me | 0.5 | 177 |
| example 2 | | | CN | 1 | 207 |
| | | | | 3 | 447 |
| Comparative | Poly[Ni(salen)] | Poly[Ni(salen)] | TEABF4-Me | 0.5 | 205 |
| example 3 | | | CN | 1 | 240 |
| | | | | 3 | 519 |

As described above, an electrochemical device of the present invention shows high output characteristics compared to comparative examples since the improvement of the energy based on the incrassation of the film is found. Cycle property is also excellent by 20000 cycles. Furthermore, it is found that, even if the electrolyte solution containing said large size ions are employed, enhanced output characteristics could be obtained.

1. An electrode material comprising polymer complex compound represented by the following graphical formula: 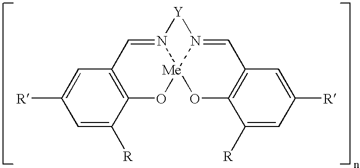
wherein Me is transition metal,
R is electron attracting substituent,
R′ is H or electron attracting substituent,
Y is 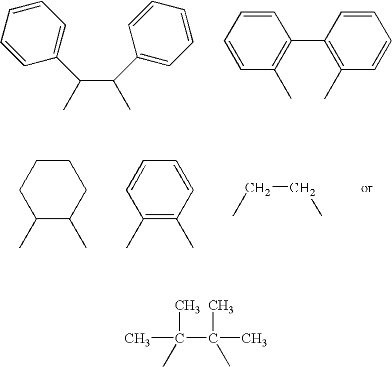
and n is an integer number of 2 to 200000.

2. An electrode material as claimed in claim 1, wherein the transition metal Me is selected from a group constituted of Ni, Pd, Co, Cu, and Fe.

3. An electrode material as claimed in claim 1, wherein the electron attracting substituent of R and R′ is selected from a group constituted of halogen, nitro group and cyano group.

4. An electrochemical device using the electrode material as claimed in claim 1.

5. An electrochemical device as claimed in claim 4, wherein the electrochemical device is a secondary battery.

6. An electrochemical device as claimed in claim 4, wherein the electrochemical device is a double electric layer capacitor.

7. An electrochemical device as claimed in claim 4, wherein the electrochemical device is an electrochemical capacitor.
